(19) United States
(12) Patent Application Publication
(10) Pub. No.: US 2017/0286940 A1
(43) Pub. Date: Oct. 5, 2017

(54) PAYMENT REGISTER SYSTEM AND METHOD OF OPERATING A PLURALITY OF PAYMENT REGISTERS

(71) Applicant: Wal-Mart Stores, Inc., Bentonville, AR (US)

(72) Inventors: Jimmie R. Clark, Fayetteville, AR (US); Michael Lawerance Payne, Centerton, AR (US); Jeffrey L. Stone, Bentonville, AR (US)

(21) Appl. No.: 15/472,679

(22) Filed: Mar. 29, 2017

Related U.S. Application Data
(60) Provisional application No. 62/316,762, filed on Apr. 1, 2016.

(51) Int. Cl. G06Q 20/20; G06K 7/14; G07G 1/00

(52) U.S. Cl. CPC G06Q 20/208; G07G 1/0018; G06Q 20/20; G06K 7/1413

(57) ABSTRACT

Described is a payment register system that can be used for accepting payment for one or more restricted items in a retail store. The payment register system includes one or more local payment registers and a remote monitor and control unit in electrical communication with each of the local payment registers. Each of the local payment registers is either operated by a local cashier, who may be under the age required to sell restricted items, or, one or more of the local payment registers may be “self-checkout” payment registers that do not have an assigned cashier. The remote monitor and control unit is used by a remote cashier to operate the local payment register, and authorize and ring up sales of restricted items that the local cashier may not be authorized to handle.

### CROSS REFERENCE TO RELATED APPLICATION

This invention claims priority to U.S. provisional patent application Ser. No. 62/316,762, filed Apr. 1, 2016 to Applicant Wal-Mart Stores Inc., and entitled “Payment Register System and Method of Operating a Plurality of Payment Registers”, the entirety of which is incorporated herein by reference.

### BACKGROUND OF THE INVENTION

### Technical Field

This invention relates to payment registers used at retail businesses to accept payment from customers, and specifically to a payment register system that uses a remote cashier to accept payment for, and authorize the sale of, restricted items.

### State of the Art

Retail stores often use cashiers to accept payment for items from customers. Issues can arise when a customer wishes to purchase restricted items such as alcohol or tobacco that must be sold and handled by a cashier over 21 years of age. Retail stores often employ cashiers that are not 21 years of age. Some restricted items have other cashier requirements, which may or may not be met by an individual cashier at a retail store. Often, a customer must wait while an authorized cashier is summoned to the payment register to authorize and ring up the sale of the restricted items. The customer purchasing the restricted items must wait, and any customers in line must wait. Cashiers or managers authorized to sell restricted items must move from one checkout line to another authorizing and ringing up sales. This is inefficient and results in unhappy customers.

Accordingly, what is needed is a payment register system that quickly and efficiently provides cashiers authorized to handle the sale of restricted items at each of a plurality of checkout registers in a retail store, without requiring that the retail store hire only cashiers authorized to sell all restricted items.

### BRIEF DESCRIPTION OF THE DRAWINGS

FIG. 1 shows a simplified block diagram of a payment register system;

FIG. 2 shows a block diagram showing further details of the payment register system of FIG. 1;

FIG. 3 illustrates a method of operating a plurality of payment registers, and

FIG. 4 illustrates a method of selling a restricted item at a local payment register of a retail store.

### DETAILED DESCRIPTION OF EMBODIMENTS OF THE INVENTION

As discussed above, embodiments of the present invention relate to payment registers used at retail businesses to accept payment from customers, and specifically to a payment register system that uses a remote cashier to accept payment for, and authorize the sale of, restricted items. Disclosed is a payment register system that is a system for accepting payment for one or more restricted items in a retail store. The payment register system includes a plurality of local payment registers and a remote monitor and control unit in communication with each of the plurality of local payment registers. The remote monitor and control unit is physically located remote from the local payment registers, sometimes in another building or city. Each of the plurality of local payment registers are used to ‘ring up’ the sales (accept payment for items) for customers at a retail store. Each of the plurality of local payment registers is either operated by a local cashier, who may be under the age required to sell restricted items, or, one or more of the local payment registers may be “self-checkout” payment registers that do not have an assigned cashier. The remote monitor and control unit is controlled by a remote cashier. The remote cashier uses the remote monitor and control unit to remotely operate each of the plurality of local payment registers when an authorized cashier is needed.

In some embodiments, the payment register system includes a robotic arm at one or more of the local payment registers. The robotic arm can be controlled by the remote monitor and control unit and used to handle the restricted items. This keeps the local cashier from handling the restricted item. In some embodiments, the local payment register includes a product recognition device. The product recognition device can detect each item presented for sale and identify restricted items automatically. In some embodiments, the remote monitor and control unit is communicatively coupled to the local payment register when the product recognition device recognizes that a restricted item has been presented for purchase at the local payment register. In some embodiments, the remote cashier uses the remote monitor and control unit to remotely monitor one or more of the local payment registers. In some embodiments, the remote cashier uses the remote monitor and control unit to remotely monitor one or more of the local cashiers operating the local payment registers. In some embodiments, a virtual reality or augmented reality communication system is used to provide communication between the remote cashier and the customer. In some embodiments, the remote cashier uses the remote monitor and control unit to authorize and/or ring up the sale of restricted items at one of the plurality of local payment registers. Both the remote monitor and control unit and each of the plurality of local payment registers include a camera to capture and transmit information. Each of the plurality of local payment registers include a scanner unit that can be used by either the customer or a local cashier to scan an item to be purchased. When a customer wishes to purchase a restricted item such as alcohol or tobacco, the remote cashier will use the remote monitor and control unit to remotely authorize the sale, and then to remotely ring up the sale. The remote cashier can instruct the customer to scan the restricted items if needed. The local cashier will receive payment, but will not be required to handle or ring up the restricted items. The remote cashier does not need to be present at the local payment register, and can be in a different location or a different building, for example.

Retail stores often use cashiers that are under the age of 21, or are otherwise unauthorized to handle and sell certain restricted items. Restricted items can be items such as alcohol, tobacco, spray paint, or any other type of item that has restrictions on its sale. The specific restrictions can be governed by state, city, or federal laws and can vary widely in different areas. The restrictions usually specify that the sale of the restricted items must be handled by an authorized cashier, and the definitions of “authorized cashier” vary with the specific restrictions. Often, many of the cashiers at a retail store are not authorized to sell some or all of the restricted items sold in the retail store. This can be an issue when a customer wishes to purchase restricted items. Typically, a customer must wait while an authorized cashier is summoned to the payment register to approve and ring up the sale of the restricted items. The customer purchasing the restricted items must wait, and any customers in line must wait. Cashiers or managers authorized to sell restricted items must move from one checkout line to another authorizing and ringing up sales. The disclosed system for accepting payment for a restricted item at a retail store allows one remote cashier to approve and ring up sales of restricted items at a number of local payment registers without the remote cashier having to be physically present at the local payment register. Sales of restricted items can be quickly and easily handled without delay, without requiring all local cashiers to be authorized to sell restricted items, and without requiring an authorized cashier to be physically present at each local payment register to authorize and ring up the sale. The remote cashier can be in a different building or city, for example.

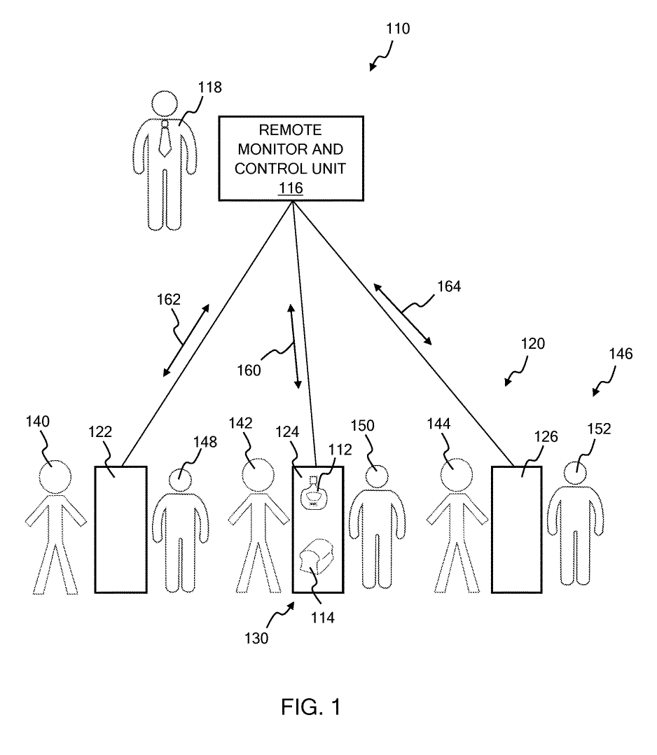

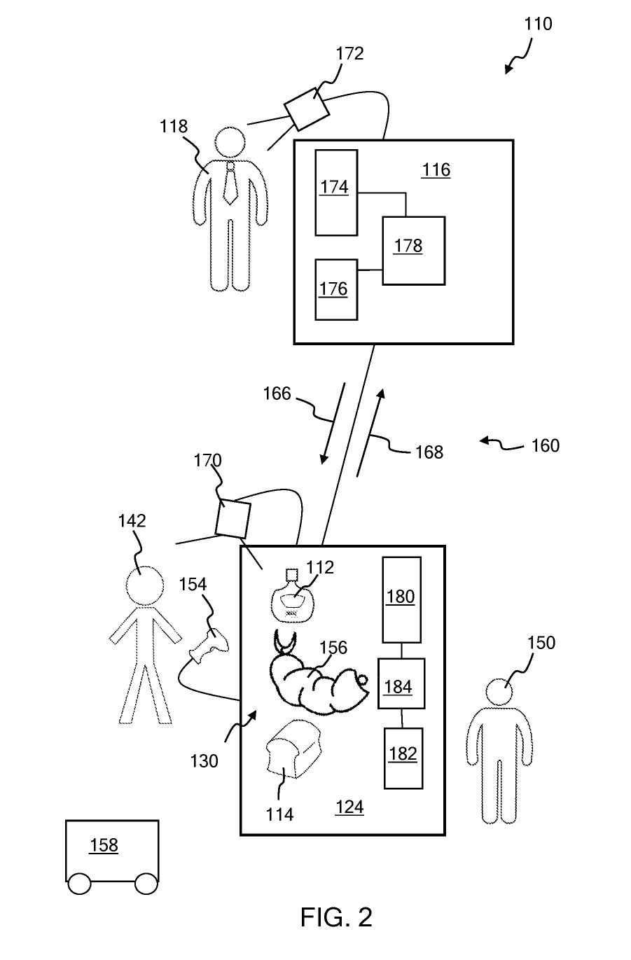

FIG. 1 and FIG. 2 show simplified diagrams of a payment register system 110. Payment register system 110 is, for example, a system for accepting payment for a restricted item at a retail store, and a system for monitoring a plurality of local cashiers, among other uses. FIG. 1 shows a simplified diagram of system 110. FIG. 2 shows further detail of a remote monitor and control unit 116 of system 110, and a local payment register 124 of system 110. Payment register system 110 includes remote monitor and control unit 116 and a plurality of local payment registers 120. Plurality of local payment registers 120 are “local” because they are located where the customer is making the purchase. Customers 140, 142, or 144 visit one of plurality of local payment registers 120, which includes local payment registers 122, 124, and 126, to purchase items. Remote monitor and control unit 116, along with a remote cashier 118 that uses remote monitor and control unit 116, are “remote” because they are located remote—a distance—from local payment registers 122, 124, and 126. Remote monitor and control unit 116 and remote cashier 118 can be in another portion of the retail store from local payment registers 122, 124, and 126, or another building, another city, or another country. Remote monitor and control unit 116 and remote cashier 118 are far enough away from local payment registers 122, 124, and 126 that it is not convenient for remote cashier 118 to walk to local payment registers 122, 124, and 126 to conduct transactions for restricted items.

Plurality of local payment registers 120 are where customers bring their items to be purchased to pay for them before leaving the retail store. Items to be purchased are “rung up” at one of plurality of local payment registers 120. In the embodiment of system 110 shown in FIG. 1, plurality of local payment registers 120 includes local payment register 122, local payment register 124, and local payment register 126. Plurality of local payment registers 120 are operated by a plurality of local cashiers 146. Local payment register 122 is operated by a local cashier 148, and, in the embodiment shown in FIG. 1, visited by customer 140. Local payment register 124 is operated by a local cashier 150, and, in the embodiment shown in FIG. 1, visited by customer 142. Customer 142 has brought a plurality of items 130 to local payment register 124 to pay for plurality of items 130. Local payment register 126 is operated by a local cashier 152, and, in the embodiment shown in FIG. 1, visited by customer 144.

Each one of plurality of local payment registers 120 are communicatively coupled to remote monitor and control unit 116. Local payment register 122 is communicatively coupled to remote monitor and control unit 116 with communication 162. Communication 162 can be wired or wireless and can be any type of communication link that communicatively couples local register 122 to remote monitor and control unit 116. Local payment register 124 is communicatively coupled to remote monitor and control unit 116 with communication 160. Communication 160 can be wired or wireless and can be any type of communication link that communicatively couples local register 124 to remote monitor and control unit 116. Local payment register 126 is communicatively coupled to remote monitor and control unit 116 with communication 164. Communication 164 can be wired or wireless and can be any type of communication link that communicatively couples local register 126 to remote monitor and control unit 116. Communication 162, 160, and 164 are two-way communications such that remote cashier 118 can communicate with customers 140, 142, and 144, and local cashiers 148, 150, and 152, and vice versa.

In the embodiment of system 110 shown in the figures, each of plurality of local payment registers 120 is operated by one of plurality of local cashiers 146, but this is not meant to be limiting. In some embodiments, one or all of plurality of local payment registers 120 are self-checkout registers that do not have a local cashier.

Remote monitor and control unit 116 is communicatively coupled to each of plurality of local payment registers 120. Remote monitor and control unit 116 is operated by remote cashier 118. Remote cashier 118 uses remote monitor and control unit 116 to monitor and control one or more of plurality of local payment registers 120 for many different purposes. Remote cashier 118 can provide remote assistance, overrides, monitoring, purchase authorizations, or many other types of assistance to one or more of plurality of local cashiers 146 at plurality of local payment registers 120, or to one or more of customers 140, 142, or 144 at plurality of local payment registers 120. Remote cashier 118 can provide this assistance without having to be physically present at a local payment register, and, in some embodiments, without having to be in the same building as plurality of local payment registers 120. In some embodiments, remote monitor and control unit 116 is in a different building from plurality of local payment registers 120.

In some embodiments, remote cashier 118 uses remote monitor and control unit 116 to remotely operate one or more than one of plurality of local payment registers 120. Remote cashier 118 can remotely operate one of plurality of local payment registers 120 if the local cashier or customer at the one of plurality of local payment registers 120 needs assistance for any reason. In some embodiments, remote cashier 118 remotely operates one or more of plurality of local payment registers 120 in response to a customer bringing one or more restricted items to the local payment registers for purchase. In some embodiments, remote cashier 118 uses remote monitor and control unit 116 to remotely monitor one or more of plurality of local cashiers 146 as they operate plurality of local payment registers 120. This ability to remotely monitor more than one local cashier and register is an efficient way to ensure local cashiers are following employee protocol, are accurately ringing up sales, are treating customers well, and in general to monitor and record employee performance of one or more of plurality of local cashiers 146. In some embodiments, remote monitor and control unit 118 records each transaction it is involved with, including video/voice/other recordings of a cashier 148, 150, or 152, for example, and a customer 140, 142, or 144, and recording each of the activities and processes of a local payment register 122, 124, and 126 and remote monitor and control unit 116, as well as remote cashier 118. These recordings can be used for security and as proof that the sale of a restricted item was handled correctly.

Remote monitor and control unit 116 includes a remote display 174, a remote input device 176, and a remote processor 178, as shown in FIG. 2. FIG. 2 shows remote monitor and control unit 116 of FIG. 1, and local payment register 124 of FIG. 1. The remainder of plurality of local payment registers 120 are not shown in FIG. 2, for simplicity of the figure. Local payment register 124 is communicatively coupled to remote monitor and control unit 116 with two-way communication 160. Remote processor 178 can be any type of computer or computing device. Remote display 174 can be any type of display and is used to display data from processor 178, as well as to display video and camera information from local payment register 124 and a local camera 170, to be discussed shortly. Remote input device 176 is a keyboard in this embodiment, but it is to be understood that remote input device 176 can be any type of input device that remote cashier 118 can use to input data into remote monitor and control unit 116.

A remote camera 172 is coupled to remote monitor and control unit 116. Remote camera 172 in this embodiment captures an image of remote cashier 118 so that customer 142 or local cashier 150 at local payment registers 124 can see an image of remote cashier 118. This makes remote cashier 118 seem closer, and assures customer 142 that remote cashier 118 is a real person.

Local payment register 124 includes a local display 180, a local processor 184, and a local input device 182. A local camera 170 is coupled to local payment register 124. Local camera 170 captures images and video to be transmitted to remote monitor and control unit 116. This can be image and video of customer 142, of identification information from customer 142, of one or more of plurality of items to be purchased 130, of local cashier 150, or any other video or image data to be transmitted to remote monitor and control unit 116.

In some embodiments one or more of remote camera 172, remote display 174, remote input device 176, remote processor 178, local display 180, local processor 184, local camera 170, and local input device 182 are part of a virtual reality or augmented reality system that is used by customer 142 and remote cashier 118 so that to customer 142 it feels like remote cashier 118 is right there next to them and communication 160 seems like in-person communication. A virtual reality or augmented reality system is a system that used a virtual or holographic display and other types of augmented reality sensory systems and devices to make the communication between customer 142 and remote cashier 118 seem like they are standing next to each other. Local display 180 may be or may include a virtual display, glasses display, or other immersive display system. In some embodiments, local display 180 is a holographic display. In some embodiments, local display 180 is a display brought in by customer 142, such as a smart phone display or a tablet display, for example.

A scanner unit 154 is coupled to local payment register 124. Scanner unit 154 in this embodiment is used to scan barcodes of plurality of items 130 in order to ring them up. Scanner unit 154 can be used to capture other types of information needed by either local payment register 124 or remote monitor and control unit 116. In some embodiments, a different data input device other than scanner 154 is used to input information required to ring up plurality of items 130.

In some embodiments, camera 170 is a product recognition device that is used to capture the product information and enter it into local processor 182. In this embodiment, camera 170 captures and identifies each of plurality of items 130 when customer 142 brings them to local payment register 124. If camera 170 operating as a product recognition device recognizes that one of plurality of items 130 is a restricted item, local payment register 124 is automatically connected to remote monitor and control unit 116 so that remote cashier 118 can authorize and execute the purchase of the restricted item.

In the embodiment of system 110 shown in FIG. 1 and FIG. 2, customer 142 has brought plurality of items 130 to local register 124 to pay for plurality of items 130. Plurality of items 130 includes a restricted portion 112, which in this embodiment is a restricted item—alcohol. Plurality of items 130 also includes an unrestricted portion 114, which in this embodiment is an unrestricted item—bread. Local cashier 150 is not authorized to handle the purchase of restricted portion 112, and so local cashier 150 requests support from remote cashier 118. In some embodiments, camera 170 is a product recognition device, and remote monitor and control unit 116 and remote cashier 118 is automatically communicatively coupled to local payment register 124 in response to camera 170 recognizing that customer 142 has presented restricted items 112 for purchase. A product recognition device is any camera, scanner, sensor, etc that can detect and capture the information from plurality of items 130. In this embodiment, local cashier 150 does not have to request support from remote cashier 118 and remote monitor and control unit 116. This is useful if local payment register 124 is a self-checkout register, for example. Local cashier 150 requests that customer 142 divide up plurality of items 130 into restricted portion 112 and unrestricted portion 114. Local cashier 150 rings up unrestricted portion 114. Remote cashier 118 appears on local display 180, and uses bidirectional communication 160 that includes both video and audio communication to begin the interaction with customer 150 and to ring up the sale of restricted portion 112.

Customer identification information 168 is sent from local payment register 124 to remote monitor and control unit 116. Customer identification information 168 can include a photo of the driver's license or other identification materials of customer 142, as well as a photo or video of customer 142, so that remote cashier 118 can ensure that customer 142 is indeed the individual identified in the driver's license or other identification materials. Customer identification information 168 can include any photo, video, or data captured by local payment registers 124 and/or local camera 170 and/or any other sensors or input devices coupled to local payment registers 124. Customer identification information 168 is used by remote cashier 118 to identify customer 142 and certify that customer 142 is authorized to purchase restricted portion 112. In some embodiments, local camera 170 captures identification information 168, and local payment register 124 sends customer identification information 168 to remote monitor and control unit 116 for use by remote cashier 118 in identifying customer 142.

In the embodiment shown in FIG. 1 and FIG. 2, once local cashier 150 requests support from remote cashier 118, remote cashier 118 instructs customer 142 to divide up plurality of items 130 into restricted portion 112 and unrestricted portion 114. Remote cashier 118 uses remote monitor and control unit 116 to instruct local cashier 150 to ring up unrestricted portion 114. Remote cashier 118 uses remote monitor and control unit 116 to instruct customer 142 to scan restricted portion 112. In some embodiments, camera 170 is a product recognition device an may be used to scan one or more of plurality of items 130. In some embodiments, camera 170 automatically scans plurality of items 130 and automatically couples remote monitor and control unit 116 when restricted item 112 is detected. Remote cashier 118 uses remote monitor and control unit 116 to instruct customer 142 on how to submit identification information 168 to remote cashier 118. Remote cashier 118 uses remote monitor and control unit 116 to display a video or photo of remote cashier 118 on local display 180, so that customer 142 can watch remote cashier 118, ask questions, and in general feel as though remote cashier 118 is present. Remote cashier 118 can instruct customer 142 to scan restricted portion 112 with scanner 154, if needed, in order to ring up restricted portion 112. Once remote cashier 118 has received customer identification information 168, as well as information regarding restricted item 112, remote cashier will either authorize or not authorize the purchase of restricted item 112 by customer 142.

If remote cashier 118 does not authorize the sale of restricted item 112 to customer 142, then customer 142 is not allowed to purchase restricted item 112.

If remote cashier 118 does authorize the sale of restricted item 112 to customer 142, remote cashier 118 uses remote monitor and control unit 116 to send authorization 166 to local payment register 124. Remote cashier 118 will use remote monitor and control unit 116 to ring up, or complete ringing up if it was partially entered already, restricted portion 112. Local payment register 124 will combine the costs of restricted portion 112 and unrestricted portion 114, and present the total to customer 142 and local cashier 150. Local cashier 150 will ensure that customer 142 has scanned each item of restricted portion 112. Local payment register 124 uses local processor 184 to process the sale of plurality of items 130. Local cashier uses local input device 182, which in this embodiment is a keyboard, and scanner 154 to ring up unrestricted portion 114. Local cashier 150 will receive payment to complete the sale of plurality of items 130. Local cashier 150 can bag unrestricted portion 114, but not restricted portion 112. Customer 142 is instructed to bag restricted portion 112 if needed.

In the embodiment shown in FIG. 2, local payment register 124 includes a robotic arm 156. Robotic arm 156 can be used to handle and bag restricted item 112. Robotic arm 156 is coupled to local payment register 124, but is controlled by remote monitor and control unit 116. Robotic arm 156 can be used to handle restricted item 112 instead of customer 142. Local cashier 150 is not authorized to handle restricted item 112, so remote cashier 118 can ask customer 142 to handle restricted item 142. It may be easier for remote cashier 118 to use remote monitor and control unit 116 to control robotic arm to handle restricted item 112. This can be particularly useful if customer 142 is unable or unwilling to handle restricted item 112.

In some cases, customer 142 may wish to purchase a restricted item that is kept in a secure enclosure—tobacco is a common example. In this case, customer 142 cannot bring the restricted item to local payment register 124, and neither can local cashier 150, who is not authorized to handle tobacco. In some embodiments, local payment register 124 can include a robotic vehicle 158 that can be programmed to obtain and deliver restricted items and bring them to customer 142. Robotic vehicle 158 can be any unmanned robot vehicle such as a robotic wheeled vehicle, a drone, a robot cart, a remotely piloted device, or any other unmanned mobile device. In this embodiment, robotic vehicle 158 delivers one or more of plurality of items 130 from a secure area to local payment register 124. Robotic vehicle 158 is controlled by remote monitor and control unit 116. Once remote cashier 118 has authorized customer 142 to purchase a restricted item such as tobacco, remote cashier 118 can use remote monitor and control unit 116 to instruct robotic vehicle 158 to deliver the restricted item to customer 142, without local cashier 150 being involved.

As has been described, remote monitor and control unit 116 is used in combination with one or more than one of a plurality of local payment registers 120 (local payment register 124 for example, as shown in FIG. 2) to allow a remote cashier 118 to remotely monitor and control local payment register 124 and to approve and ring up the sale of a restricted portion 112 to a customer 142. Remote monitor and control unit 116 allows remote cashier 118 to participate in the sale remotely, from a different location, or a different building. Remote monitor and control unit 116 and remote cashier 118 may be in a different check-out aisle adjacent local payment register 124, or a different location in the same building as local payment register 124, or in a different building and/or city than local payment register 124. System 110 transmits two-way video, still image, and audio data between local payment register 124 and remote monitor and control unit 116 so that remote cashier 118 can feel like they are present at local payment register 124 and can accurately check the identification information 168 of customer 142 and authorize the sale. Customer 142 can quickly and easily be authorized to purchase restricted item 112 without having to wait for an authorized cashier to be physically present at local payment register 124.

Remote cashier 118 can use remote monitor and control unit 116 to authorize the sale of restricted items, to handle over-rides, to monitor the performance of local cashier 150, and to handle any other instructive or informative actions needed by local cashier 150. Remote cashier can use a robotic arm 156 or a robotic vehicle to handle restricted items.

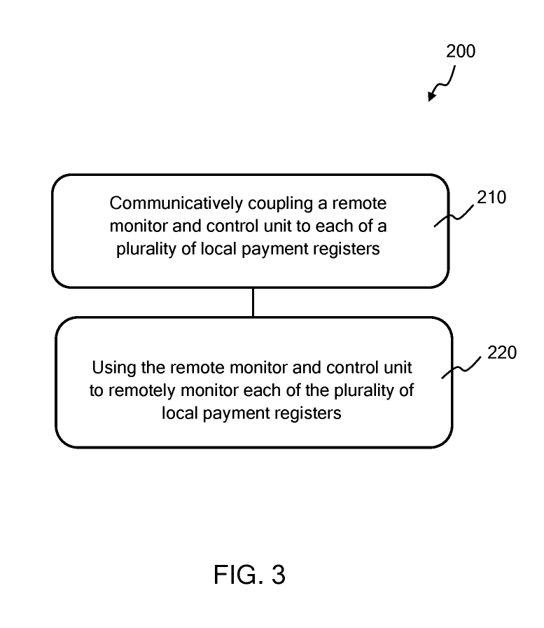

FIG. 3 illustrates a method 200 of operating a plurality of payment registers. Method 200 includes an act 210 of communicatively coupling a remote monitor and control unit to each of a plurality of local payment registers. Method 200 also includes an act 220 of using the remote monitor and control unit to remotely monitor each of the plurality of local payment registers. Method 200 can include many other acts.

In some embodiments, method 200 includes instructing a local cashier at one of the local payment registers to scan a first portion of a customer's purchase. In some embodiments, method 200 includes instructing the customer to scan a second portion of the customer's purchase. In some embodiments, the first portion is an unrestricted portion and the second portion is a restricted portion. In some embodiments, method 200 includes instructing the customer to divide up a plurality of items to be purchased into the first portion and the second portion. In some embodiments, method 200 includes using the remote monitor and control unit to remotely control each of the local payment registers. In some embodiments, method 200 includes instructing the customer to divide their items for purchase into an unrestricted portion and a restricted portion. In some embodiments, method 200 includes transmitting customer identification information from one of the local payment registers to the remote monitor and control unit. In some embodiments, method 200 includes using the remote monitor and control unit to ring up the restricted portion in response to approving the customer identification information. In some embodiments, method 200 includes using the one of the local payment registers to ring up the unrestricted portion.

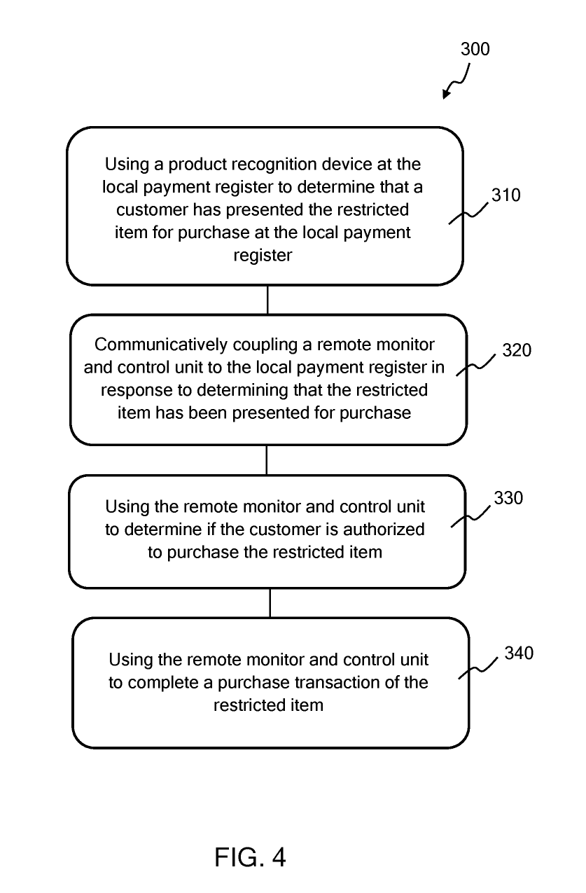

FIG. 4 illustrates a method 300 of selling a restricted item at a local payment register of a retail store. Method 300 includes an act 310 of using a product recognition device at the local payment register to determine that a customer has presented the restricted item for purchase at the local payment register. The product recognition device can be a camera, a scanner, or any other type of sensor device that can detect and identify a restricted item brought to the local payment register.

Method 300 also includes an act 320 of communicatively coupling a remote monitor and control unit to the local payment register in response to determining that the restricted item has been presented for purchase. The remote monitor and control unit is located remote from the local payment register. In this embodiment, the product recognition device determines that the restricted items has been brought to the payment register, and automatically couples the remote monitor and control unit, as well as a remote cashier, so that the purchase of the restricted item can be authorized and executed.

Method 300 also includes an act 330 of using the remote monitor and control unit to determine if the customer is authorized to purchase the restricted item. Two-way communications such as video, displays, augmented reality or virtual reality systems can be used to communicatively couple the remote cashier and the customer and to deliver authorization documents and information to the remote cashier through the remote monitor and control unit so the remote cashier can determine if the customer is authorized to purchase the restricted item.

Method 300 also includes an act 340 of using the remote monitor and control unit to complete a purchase transaction of the restricted item. The remote cashier can use the remote monitor and control unit to ring up the purchase of the restricted item. In some embodiments, the remote cashier uses the remote monitor and control unit to control a robotic arm located at the local payment register. The robotic arm can be used to handle the restricted item at the local payment register.

In some embodiments a virtual reality communication device is used to communicatively couple the customer and a remote cashier located at the remote monitor and control unit. In some embodiment, method 300 includes using the remote monitor and control unit to record the purchase transaction of the restricted item. In some embodiment, method 300 includes using a robotic vehicle to deliver the restricted item to the customer at the local payment register.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A payment register system comprising:
a plurality of local payment registers, wherein a customer uses one of the plurality of local payment registers to pay for a plurality of items to be purchased;
a remote monitor and control unit located remote from the plurality of local payment registers, wherein the remote monitor and control unit is communicatively coupled to each of the plurality of local payment registers, and wherein a remote cashier uses the remote monitor and control unit to remotely operate each of the plurality of local payment registers;
a robotic arm coupled to a first one of the plurality of local payment registers, wherein the robotic arm handles the plurality of items to be purchased, and wherein the robotic arm is controlled by the remote monitor and control unit.

2. The system of claim 1, wherein the remote cashier uses the robotic arm to handle a restricted item to be purchased if a local cashier operating the first one of the plurality of local payment registers is not authorized to handle the restricted item.

3. The system of claim 1, wherein each of the plurality of local payment registers is operated by one of a plurality of local cashiers, and wherein the remote monitor and control unit records the customer paying for the plurality of items to be purchased, including recording each activity of the plurality of local payment registers and the remote monitor and control unit.

4. The system of claim 1, further comprising a product recognition device coupled to the first one of the plurality of local payment registers, wherein the remote cashier uses the remote monitor and control unit to instruct the customer to use the product recognition device to scan one or more of the plurality of items to be purchased.

5. The system of claim 1, wherein the first one of the plurality of local payment registers comprises a bar code scanner, and wherein the remote cashier uses the remote monitor and control unit to instruct the customer to use the bar code scanner to scan a first item to be purchased, and wherein the remote cashier uses the remote monitor and control unit to instruct a local cashier to use the bar code scanner to scan a second item to be purchased.

6. The system of claim 1, wherein the first one of the plurality of local payment registers comprises a local camera, wherein the local camera captures customer identification information from the customer, and wherein the first one of the plurality of local payment registers sends the customer identification information to the remote monitor and control unit.

7. The system of claim 6, wherein the first one of the plurality of local payment registers comprises an augmented reality display, wherein the customer uses the augmented reality display to communicate with the remote cashier.

8. The system of claim 1, further comprising a robotic vehicle, wherein the robotic vehicle delivers one of the plurality of items to be purchased from a secure area to the customer at the first one of the plurality of local payment registers.

9. A method of selling a restricted item at a local payment register of a retail store, the method comprising:
using a product recognition device at the local payment register to determine that a customer has presented the restricted item for purchase at the local payment register;
communicatively coupling a remote monitor and control unit to the local payment register in response to determining that the restricted item has been presented for purchase, wherein the remote monitor and control unit is located remote from the local payment register;
using the remote monitor and control unit to determine if the customer is authorized to purchase the restricted item; and
using the remote monitor and control unit to complete a purchase transaction of the restricted item.

10. The method of claim 9, further comprising controlling a robotic arm located at the local payment register with the remote monitor and control unit, wherein the robotic arm is used to handle the restricted item at the local payment register.

11. The method of claim 9, further comprising using a virtual reality communication device to communicatively couple the customer and a remote cashier located at the remote monitor and control unit.

12. The method of claim 9, further comprising using the remote monitor and control unit to record the purchase transaction of the restricted item.

13. The method of claim 9, further comprising using a robotic vehicle to deliver the restricted item to the customer at the local payment register.

14. A payment register system at a retail store, the system comprising:
a local payment register operated by a local cashier, wherein the local payment register comprises a product recognition device;
a remote monitor and control unit operated by a remote cashier and located remote from the local payment register, wherein the local payment register is communicatively coupled to the remote monitor and control unit in response to the product recognition device identifying a restricted item presented for purchase at the local payment register;
wherein the remote cashier uses the remote monitor and control unit to operate the local payment register to accept payment for the restricted item.

15. The system of claim 14, further comprising a robotic arm coupled to the local payment register, wherein the remote monitor and control unit controls the robotic arm to handle the restricted item.

16. The system of claim 14, further comprising a virtual reality communication system communicatively coupling the remote cashier and a customer purchasing the restricted item.

17. The system of claim 16, wherein the remote cashier authorizes the customer to purchase the restricted item in response to receiving customer identification information using the virtual reality communication system

18. The system of claim 17, wherein the remote monitor and control system records the purchase transaction of the restricted item and all communication using the virtual reality communication system.
